(19) United States
(12) Patent Application Publication
(10) Pub. No.: US 2025/0014052 A1
(43) Pub. Date: Jan. 9, 2025

(54) SYSTEM AND METHOD FOR AUTOMATICALLY DETECTING DIGITAL ACCOUNT TAKEOVER TRANSACTION IN DIGITAL TRANSACTIONS

(71) Applicant: THE TORONTO-DOMINION BANK, TORONTO (CA)

(72) Inventors: BARNALI BHATTACHARJEE, HAMILTON (CA); DAERIAN ASHAN DILKUMAR, TORONTO (CA); HARSHUL VARMA, TORONTO (CA); KEVIN JOE AKAOKA, TORONTO (CA); MICHELLE ERICA LEVINE, TORONTO (CA); YUQIN SABRINA SUN, TORONTO (CA); CHAD A. KOZIEL, TORONTO (CA)

(21) Appl. No.: 18/764,805

(22) Filed: Jul. 5, 2024

Related U.S. Application Data
(60) Provisional application No. 63/512,535, filed on Jul. 7, 2023.

(51) Int. Cl. G06Q 30/018; G06N 5/025

(52) U.S. Cl. CPC G06Q 30/0185; G06N 5/025

(57) ABSTRACT

A model engine is provided for managing transactions for one or more computing devices over a network. There is provided a machine learning model trained and tested on historical transaction data including labelled fraud data, to provide a target signal indicative of a likelihood of fraud within a given transaction, generating an ensemble of decision trees. The engine further includes extracting a set of rules by traversing each tree in the ensemble of decision trees from a root node to each leaf node of the tree, each path from the root node to a particular leaf node including splitting criterion providing a rule to form a set of rules. A proactive risk management system is also provided for applying the set of rules to a new transaction and when at least one rule is met, triggering predetermined actions on at least one computing device on the network.

### CROSS-REFERENCE TO RELATED APPLICATION

This application claims the benefit of U.S. Provisional Patent Application No. 63/512,535, filed Jul. 7, 2023, and entitled “SYSTEM AND METHOD FOR AUTOMATICALLY DETECTING DIGITAL ACCOUNT TAKEOVER FRAUD IN DIGITAL TRANSACTIONS”, the entire contents of which is incorporated by reference herein in its entirety.

### FIELD

The present disclosure relates to systems and methods for automatically detecting, in real-time, digital account takeover transaction in digital transactions or interactions received across various digital channels within a networked computing environment.

### BACKGROUND

Detection and prevention of unauthorized digital activities are critical components of digital security systems, designed to protect computing systems, servers, networks, and various digital environments. Analytics and rules-based monitoring solutions aim to solve such concerns. Despite their widespread adoption, these methods possess notable technical shortcomings that hinder their ability to effectively address the continuously evolving digital landscape of unauthorized digital transactions and activities.

Analytics and rules-based monitoring solutions detect unauthorized activities by analyzing transactions or interactions against predefined rules and patterns. However, these solutions also face significant technical challenges, such as reliance on static rules that must be manually updated to reflect new digital patterns, leading to a reactive and often lagging approach. Scalability issues arise as the volume of transactions or digital interactions increases, causing performance bottlenecks due to the need to evaluate each computing transaction or digital interaction against an expanding set of rules. The rigidity of predefined rules can result in a high number of false positives, impacting operational efficiency and user satisfaction. Furthermore, rules-based systems are often limited in scope, focusing narrowly on specific types of unauthorized activities, and failing to detect sophisticated or emerging digital transaction or interaction schemes. The ongoing effort required to update and maintain the rules imposes a significant maintenance overhead on computing systems and unnecessary waste of computing resources. These technical shortcomings underscore the need for more advanced and real time adaptive approaches to unauthorized digital activity detection in real-time.

There is thus a need for improved computing systems and devices to address at least some of the shortcomings.

### SUMMARY

The systems and methods disclosed herein provide a system, method and computer program product for globally managing and analyzing transaction requests, in real-time, for one or more transaction servers and to obviate or mitigate at least some of the above presented disadvantages.

In at least one aspect, there is provided a model engine apparatus for receiving a plurality of transactions from at least one transaction server and managing the transactions for one or more computing devices over a network, the model engine apparatus comprising: a machine learning model using a supervised learning model being trained and tested on historical transaction data including labelled fraud data received from the at least one transaction server, configured to provide a target signal indicative of a likelihood of fraud within a given transaction, the machine learning model generating an ensemble of decision trees as output; a trees model for extracting a set of rules by traversing each tree in the ensemble of decision trees from a root node to each leaf node of the tree, each path from the root node to a particular leaf node including splitting criterion providing a rule to form a set of rules for the ensemble; and a proactive risk management system for receiving the set of rules, and storing the rules in a database for applying the set of rules to compare to a new transaction received from the at least one transaction server, and in response to at least one rule being met for the new transaction, triggering predetermined actions on at least one computing device on the network associated with the new transaction based on the at least one rule being met.

In a further aspect, triggering the predetermined actions further comprises triggering generating an alert and presenting on a display unit of the at least one computing device, a first notification portion indicative of likelihood of fraud, a second notification portion indicative of the at least one rule met and a third notification portion indicative of metadata identifying the new transaction.

In a further aspect, the model engine apparatus comprises receiving feedback from the at least one computing device, via receiving user input on the display unit modifying the likelihood of fraud, and providing such to the machine learning model to cause the machine learning model to be retrained to incorporate the feedback and thereby generate a new set of rules for the proactive risk management system.

In a further aspect, the machine learning model further receives an existing set of rules from the proactive risk management system and additional historical data from the proactive risk management system indicative of modifications to the set of rules thereby causing regeneration of the machine learning model.

In a further aspect, the trees model is further configured to reduce the set of rules prior to providing to the proactive risk management system by grouping together similar rules or common rules, the similar rules being grouped together based on a similarity metric.

In a further aspect, the trees model is further configured to reduce the set of rules prior to providing to the proactive risk management system by ranking each rule in the set of rule based on effect on determining the target signal and selecting a top defined number of set of rules for the providing to the proactive risk management system for implementation on incoming transactions.

In a further aspect, the trees model is further configured to translate the set of rules into SQL rules in a format compatible with the proactive risk management system.

In a further aspect, the proactive risk management system is further configured to trigger a staggered response to the at least one rule being met, wherein the staggered response defined a different level of response to be performed by the computing devices being managed, the different level of response comprising at least one of: denying the new transaction; generating an alert to the computing devices associated with the new transaction; generating an alert to the computing devices requesting the new transaction; and requesting additional authentication from the computing devices requesting the new transaction.

In a further aspect, the machine learning model is configured to train on a subset of the historical transaction data, the machine learning model to rebalance the subset until representative of a proportion of fraudulent transactions versus normal transactions in a complete set of the historical transaction data.

In another aspect, there is provided a computer implemented method for receiving a plurality of transactions from at least one transaction server and managing the transactions for one or more computing devices over a network, the method comprising: generating a machine learning model using a supervised learning model being trained and tested on historical transaction data including labelled fraud data received from the at least one transaction server, the machine learning model configured to provide a target signal indicative of a likelihood of fraud within a given transaction, the machine learning model generating an ensemble of decision trees as output; applying a trees model for extracting a set of rules by traversing each tree in the ensemble of decision trees from a root node to each leaf node of the tree, each path from the root node to a particular leaf node including splitting criterion providing a rule to form a set of rules for the ensemble; and providing the set of rules to a proactive risk management system and storing the rules in a database and applying the set of rules upon receiving a new transaction from the at least one transaction server, and in response to at least one rule being met for the new transaction, triggering predetermined actions on at least one computing device on the network associated with the new transaction based on the at least one rule being met.

In a further aspect, there is provided the method wherein triggering the predetermined actions further comprises triggering generating an alert and presenting on a display unit of the at least one computing device, a first notification portion indicative of likelihood of fraud, a second notification portion indicative of the at least one rule met and a third notification portion indicative of metadata identifying the new transaction.

In a further aspect, the method comprises receiving feedback from the at least one computing device, via receiving user input on the display unit modifying the likelihood of fraud and providing such to the machine learning model to cause the machine learning model to be retrained to incorporate the feedback and thereby generate a new set of rules for the proactive risk management system.

In a further aspect, the method comprises the machine learning model receiving an existing set of rules from the proactive risk management system and additional historical data from the proactive risk management system indicative of modifications to the set of rules thereby causing regeneration of the machine learning model.

In a further aspect, the method comprises reducing the set of rules via the trees model prior to providing to the proactive risk management system by grouping together similar or common rules, the similar rules being grouped together based on a similarity metric.

In a further aspect, the method comprises reducing the set of rules, via the trees model prior to providing to the proactive risk management system by ranking each rule in the set of rule based on effect on determining the target signal and selecting a top defined number of set of rules for the viding to the proactive risk management system for implementation on incoming transactions.

In a further aspect, the method comprises translating the set of rules into SQL rules in a format compatible with the proactive risk management system prior to providing to the proactive risk management system for application.

In a further aspect, the method comprises triggering a staggered response to the at least one rule being met, wherein the staggered response defined a different level of response to be performed by the computing devices being managed, the different level of response comprising at least one of: denying the new transaction; generating an alert to the computing devices associated with the new transaction; generating an alert to the computing devices requesting the new transaction; and requesting additional authentication from the computing devices requesting the new transaction.

In a further aspect, there is provided the method wherein the machine learning model is configured to train on a subset of the historical transaction data, further comprises rebalancing the subset until representative of a proportion of fraudulent transactions versus normal transactions in a complete set of the historical transaction data.

In another aspect, there is provided a non-transitory computer readable medium having instructions thereon, which when executed by a processor of a computer configure the computer to perform a method for receiving a plurality of transactions from at least one transaction server and managing the transactions for one or more computing devices over a network, the method comprising: generating, by the processor a machine learning model using a supervised learning model being trained and tested on historical transaction data including labelled fraud data received from the at least one transaction server, the machine learning model configured to provide a target signal indicative of a likelihood of fraud within a given transaction, the machine learning model generating an ensemble of decision trees as output; applying, by the processor, a trees model for extracting a set of rules by traversing each tree in the ensemble of decision trees from a root node to each leaf node of the tree, each path from the root node to a particular leaf node including splitting criterion providing a rule to form a set of rules for the ensemble; and providing, by the processor, the set of rules to a proactive risk management system and storing the rules in a database and applying the set of rules upon receiving a new transaction from the at least one transaction server, and in response to at least one rule being met for the new transaction, triggering predetermined actions on at least one computing device on the network associated with the new transaction based on the at least one rule being met.

### BRIEF DESCRIPTION OF THE DRAWINGS

These and other features will become more apparent from the following description in which reference is made to the appended drawings wherein:

FIG. 1 is a block diagram of a computing environment and system for automatically detecting digital fraudulent transactions or fraudulent computing interactions and performing subsequent computing actions, in accordance with one or more embodiments;

FIG. 2 is a further block diagram of the real-time prediction engine of FIG. 1, in accordance with one or more embodiments;

FIG. 3 is an example operation of the real-time prediction engine of FIGS. 1 and 2, in accordance with one or more embodiments;

FIG. 4 is an example visualization of a rule set provided by the trees rule model of the prediction engine of FIGS. 1 and 2, in accordance with one or more embodiments;

FIG. 5 is an example screen shot of a user interface displaying a list of transactions processed by the proactive risk management system and the engine of FIGS. 1 and 2 and the associated alerts displayed on a viewing portion of the interface of a computing device receiving output from the engine, in accordance with one or more embodiments; and

FIG. 6 is an example computing device implementing the real-time prediction engine of FIGS. 1-3, in accordance with one or more embodiments.

### DETAILED DESCRIPTION

Predictive risk models (PRMs) may utilize historical data to predict the likelihood of unauthorized activities. However, when used as a stand alone, they may exhibit several limitations that impact their effectiveness, including heavy reliance on the quality and quantity of historical data, the necessity for frequent updating of rules, and the requirement for substantial domain expertise in feature engineering. PRMs used as a standalone for prediction may be computationally demanding, resulting in slower processing times and increased operational costs. Used as a standalone, such PRM systems also often lack interpretability making it difficult to trust the model's decision-making process.

Conveniently, in at least some aspects, the methods and systems presented herein apply a unique computing architecture, e.g. as shown as real-time prediction model engine 100 which leverages multiple computing systems and modelling platforms in a computing environment 150 including PRM systems, to cooperate together to globally manage transaction requests and detect fraudulent activity and flag subsequent computing alerts for computerized action in real time.

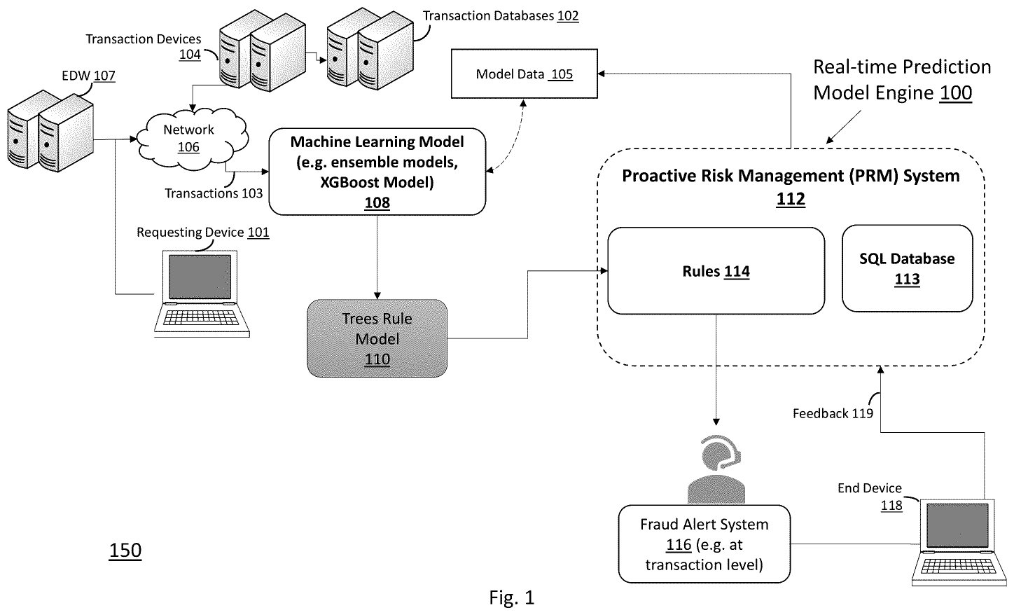

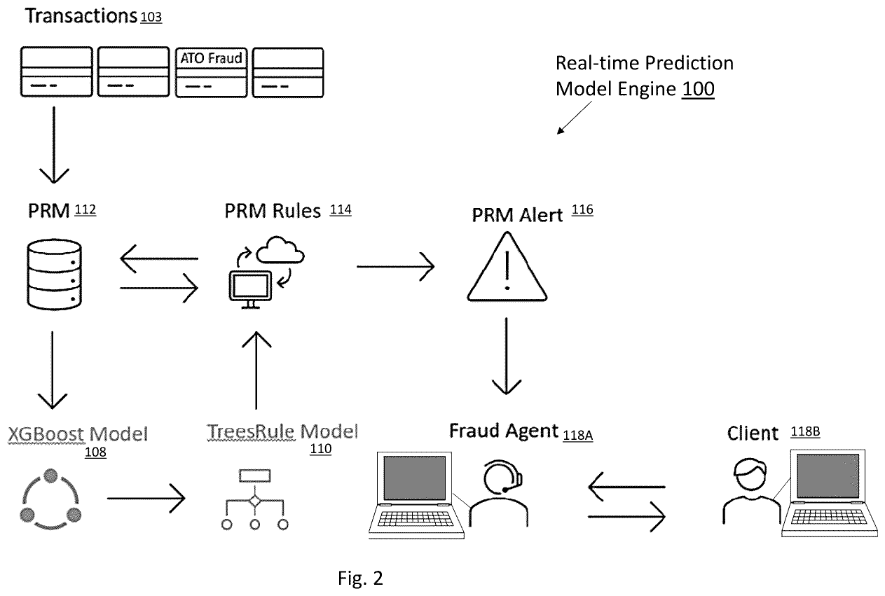

The disclosed solution, in at least some aspects, utilizes a combination of a computerized customer risk model, a transaction risk model and trees rule model to detect and manage transaction requests including fraudulent account takeover transactions. As shown in FIGS. 1 and 2, a combination of machine learning models, PRM systems and Trees rules based models is applied in a unique manner configured to process real-time transactions, learn which transactions are likely to be fraudulent and use the approximated model to extract relevant rules via a tree based rule model and introduce them proactively into a PRM system for detecting and flagging fraud transactions and generating fraud alerts and actions for subsequent computing devices (e.g. denying current or subsequent fraud transactions or flagging associated computing devices as unauthorized for subsequent communications and transactions), as needed. In one or more aspects, the system may be configured to provide a staggered digital response to the transaction request based on a determination of the fraud probability, including stopping transactions, alerting requesting computing devices, or transaction servers processing such transactions, and notifying associated devices of potential fraud and associated probability, adjusting digital security protocols and permissions associated with a potentially fraudulent device, etc.

In at least some implementations, a method and apparatus for processing and managing transactions in a networked computing environment of various electronic data sources and systems, such as enterprise data warehouse systems, database servers, web database analytics and behaviour processing systems, various data repositories, etc. for use with computer programs or software applications whose functions are designed primarily to allow read or write access for managing, updating and processing transactions to one or more databases such that data in these databases contain secure, e.g. non-fraudulent data.

It is noted that while examples of the present disclosure are described with reference to transactions and transaction systems, databases or servers, other types of digital data such as communication data, or data exchanges as may be communicated in a networked computing environment including a data exchange platform, and/or a data management system and/or an interaction management system may be envisaged within the environment of FIG. 1. Generally, the environment 150 may be configured in facilitating, managing and flagging digital transactions, communications, exchanges or interactions between different entities having a high likelihood of fraudulent indication and triggering subsequent actions to be performed for controlling and managing communications based on the triggering.

Generally, in some examples, account takeovers (ATO) represent a severe form of digital fraud wherein unauthorized individuals gain access to an individual's online banking credentials. In this example, once access is obtained, fraudsters can exploit this access to perpetrate various illicit activities, including unauthorized fund transfers or other digital transactions aimed at liquidating or manipulating accounts. Furthermore, they may manipulate database records and transaction databases such as customer information to facilitate fraudulent activities related to credit products, thereby exacerbating the digital security risk and impact on affected entities.

In some examples, fraudulent users may bypass digital security and identity validation checks in place by using compromised credentials.

Historical methods to mitigate such takeovers manually define rules or use static rules to flag fraudulent transactions based on past occurrences which are unreliable and difficult to identify and maintain.

In one or more aspects, the environment 150 comprises a machine learning model 108 receiving transactions 103 from multiple varied data sources across a network 106 including transaction devices 104 communicating with transaction databases 102 and various channels including electronic data warehouse (EDW 107). The transaction device 104 may also be a transaction server used to manage and execute transactions in a reliable manner. Generally, a digital transaction may be a set of related digital tasks treated as a single action and may encompass various types of digital exchanges between computing devices. The data sources for the transaction may also include but not limited to: electronic data warehouses (EDW) 107 containing a data warehouse repository of customer centric information, application servers, various mobile and computing devices, data servers which monitoring and analyze customer and behaviour trends in an online environment, web traffic analytics and behaviour information servers collecting data across web pages and mobile applications, etc.

Referring to FIGS. 1 and 2, a real-time prediction model engine 100 is provided comprising the machine learning model 108, a trees rule model 110, a proactive risk management (PRM) system 112 including a database or repository of rules 114, and a fraud alert system 116 for providing fraud alerts, or flagging transactions including a potential likelihood of fraud and subsequent actions on an end device 118 which may be a requesting transaction device and/or a device managing transactions for the requesting transaction.

Generally, the proactive risk management (PRM) system 112 is used to monitor and manage fraudulent transactions received in a networked computing environment across multiple digital channels (debit cards, online channels, point-of-sale systems, branch computing devices, etc.). PRM system 112 contains the data on transactions and fraud tagging. In some examples, a transaction may include but not limited to a monetary and/or non-monetary transaction, or digital interaction, or exchange of data across computing entities including web traffic analytics in the environment 150, inputs on webpage, mobile applications, or digital mobile wallets, etc. In some aspects, the PRM system 112 is an SQL-based system so the model results may be implemented through SQL rules or a simple SQL-based model.

Referring to FIG. 1, the engine 100 combines 3 different computing models to manage, detect and control electronic transactions or interactions, such as fraudulent transactions including a customer or user risk model (e.g. an ensembled machine learning model 108), a transaction risk model (e.g. existing within or as a module communicating with a PRM system 112 which may include a set of rules 114 to be applied to the input transactions in real-time) and a trees rule model 110 which processes the ensemble tree models and extracts rules from each of the decision trees.

Conveniently, the engine 100, by separating the models into distinct models (e.g. 108, 110 and 112) reduces the amount of data integration with the PRM system, which may in some aspects be an externally managed, legacy system, thereby providing interpretability and improved adaptability of the computing model for predicting a target variable, such as likelihood of fraud in transactions communicated over a networked system such as shown in FIG. 1.

In at least some aspects, the transactions 103 may include a monetary or non-monetary transactions such as may be made via user input on one or more computing devices, including a requesting device 101, end device 118, etc. and/or retrieved from transaction databases 102 via transaction devices 104 monitoring networked computing devices transacting in relation to an entity. Such input may be made via a webpage, a mobile application, or a mobile wallet, etc. The transactions may include but not limited to: e-transfers, transfers between a source computer and a destination computer, adding or modifying recipients for transfers, one time password prompts, new logins, address changes, security contact information changes, etc.

### Machine Learning Model 108

The machine learning model 108 is preferably a gradient boosted tree model generated to predict probability of fraudulent transactions within all transactions 103, e.g. as may be received from various data sources such as transaction devices 104, transaction databases 102, requesting device 101 and/or additional computing devices, not shown, across the network.

In at least some aspects, the model 108 is an extreme gradient boosted model (XGboost) configured to extract historical data directly from the PRM system 112 and/or transaction devices 104 (e.g. stored as model data 105). The historical data in the model data 105 may be split based on time into a training set and a testing data set (the testing set comprising both an actual testing set and a validation data set). In some implementations, the data may be labelled as account takeover fraud or not; or fraudulent or not; or flagged as problematic or questionable, etc.

Additionally, in at least some aspects, feature engineering may be performed on the historical data to determine features of high importance for generating an indication of fraudulent or not, and additional features may be added for tracking whether a transaction may be fraud, such as, but not limited to: Time since the last transaction; Frequency of transactions per users; transaction amount deviation from the user's average; change of contact information associated with one or more accounts stored on a device; addition of new source or destination device for data transfers; geolocation differences; computing device or IP address changes of device performing the transaction (e.g. via a mobile wallet, mobile application, website or otherwise), etc. In at least some aspects, the machine learning model 108 may be configured to only examine and extract a set of data events and associated features which occurred during a given time period (e.g. prior to the occurrence of fraud, determine all events and associated features within the last X days). Thus, the machine learning model 108 may have defined time windows, generated based on training the model on historical data and the prior average or pattern of time window to occurrence of fraud timeline.

In at least some aspects, during generation of the machine learning model 108, the engine 100 is configured to perform a sampling of the transaction data available to it, e.g. the historical data and ensure that the sampling population is not biased and accurately reflects desired ratio of fraudulent transactions to normal transactions. If such a ratio, is not achieved, the machine learning model 108 may request and gather additional transaction data being labelled with an indication of fraudulent or not, such as from other computing devices across the network 106, including the transaction device 104, the requesting device 101, the end device 118, etc. Alternatively, if feature importance is performed first on the features such as to utilize only features having a high importance in being correlated to fraud indication, then additional features may be introduced to the model 108 via the model data 105 to ensure a predefined desired ratio of target to transaction (e.g. how many fraud transactions relative to the number of total transactions).

In some implementations, in the context of using XGBoost in the model 108 for fraud detection, ensuring that the sampling strategy is representative of the population is crucial because gradient boosting models build an ensemble of trees sequentially, with each tree trained to correct the errors of the previous ones. This process relies on gradient descent to minimize the loss function, which measures the difference between predicted and actual values. If the sample used for training is biased or unrepresentative, the model 108 may learn patterns that do not generalize well to the entire population, leading to poor performance. In fraud detection, where data is often imbalanced, with far fewer fraud cases than non-fraud cases, a balanced and representative sample helps the model understand and detect fraud more accurately. Thus, the model 108 may be configured as described above to verify that the ratio of the sampling meets a desired threshold (e.g. that the ratio of fraud transactions to the total transactions meets or exceeds a desired value).

In some aspects, one option step performed by the machine learning model 108 is to reduce the size of the data used for training/testing as it can improve the efficiency and effectiveness of training the XGBoost model. This can be achieved through feature selection implemented by the machine learning model, which retains only the most important features, and by down sampling the majority class or upsampling the minority class to address data imbalance. Dimensionality reduction techniques, such as Principal Component Analysis (PCA), can also be employed to reduce the number of features while preserving most of the data's variance. Additionally, aggregating data can simplify the dataset.

By preprocessing the data, applying appropriate sampling techniques, and reducing its size, the XGBoost model provided in the machine learning model 108 may be trained more efficiently, focusing on the most relevant features and patterns, thereby enhancing its ability to detect fraudulent transactions accurately.

Put another way, when gradient modelling is used for the machine learning model 108 the sampling strategy has to be close to the population and thus, the engine 100 may be configured to reduce the size of the data (e.g. model data 105) to ensure the sampling set meets the desired balance.

In one or more aspects, the machine learning model 108, is based on a gradient boosted model, trained and generated specifically as described herein. In one example implementation, the gradient boosted model is an ensemble technique that combines the predictions of multiple weak learners (e.g. decision trees) to create a strong predictive model. Each subsequent tree in the sequence is trained to correct the errors made by the previous ones, effectively boosting the performance of the model.

In one example implementation, the machine learning model 108 predicts account takeover fraud using EDW 107 data and/or transaction device 104 data on a user or customer level based on all transaction stored in a data warehouse that encompasses and stores all of an entity's electronic data from various sources across the entire entity (e.g. computing devices communicating across the network 106, including the requesting device 101, the transaction devices 104, the transaction databases 102, the end device 118, the real-time prediction model engine 100, etc.). Some of the features defined in the machine learning model 108 may include, the target variable and historical model data 105 (e.g. flag historical data, product type, mark type, etc.), sampling ratio (e.g. total transaction, percentage used for training and percentage for testing, etc.), feature set (e.g. total features based on various channels of EDW, e.g. phone, mobile, web, physical branch, etc.), results of sample (ratio of false positives to true positive, etc.).

In another example implementation, the machine learning model 108, receives model data using PRM data and predicts, in one example, account take over fraud at the transaction level. This may include the following characteristics in the model:
a. Target: caedaco3_PRM.detail_flag_history (identified by product_type and nd_mark_type)
b. Sampling: 1% (approx. 10 MM rows) of the entire population (defined as all transactions occurred in certain time period). 80% of which was used as the training set, and 20% for the testing set.
c. Features: Feature engineering was conducted to create X features (features that contained over 50% of null values and irrelevant columns were reduced).
d. Results: 6:1 FP:TP Ratio. Out of the 20% testing set, in this example, the transactions that are associated with higher risk scores had better FP:TP ratio. So, the top 0.005% of transactions in the testing set was used to extrapolate the total annual amount of ATO fraud that could be captured in our sample and in the entire population.

In another example implementation, the machine learning model 108 is configured to predict digital account take over fraud in digital transactions communicated in a networked environment. As noted earlier, in some aspects, digital account take over fraud is a monetary or non-monetary transaction that may happen over digital platforms for an entity, such as across the environment 150, including various digital channels such as webpages, mobile applications, or mobile wallets, etc. The prediction may also be performed on a transaction level.

### Trees Rule Model 110

In one aspect, the trees rule model 110 is configured to extract rules from a complex ensemble machine learning model 108, such as a boosted tree model or XGBoost. In this approach, each tree within the ensemble is analyzed to derive a series of decision rules based on the paths taken from the root to the leaf nodes in the machine learning model 108. In some example aspects, these rules may be structured as if-else statements or logical conditions or SQL statements that mimic the decision-making process of the original machine learning model 108. Note that the machine learning model 108 may be trained and tested using model data 105. By traversing the ensemble of trees (e.g. as provided by the machine learning model 108) and examining the splitting criteria at each node, the trees rule model 110 identifies common patterns and thresholds that contribute most significantly to the model's predictions. In at least some aspects, the trees rule model 110 is configured to distill the complex predictive behavior of the machine learning model 108 into a set of simplified, interpretable rules (e.g. SQL statements) that can be directly implemented in operational systems such as PRM system 112 for rules 114, facilitating real-time decision-making and improving transparency in machine learning model outputs. Additionally, the rules derived from the decision trees of the model 108 can be used by the alert system to derive additional information from the metadata of the transaction relating to the origins and communication paths of the transaction including IP addresses, MAC addresses, device types, device IDs, etc.

Generally, the trees rule model 110 is configured to traverse through the set of ensemble decision trees generated by the ensemble models of the machine learning model 108 and extract rules from each leaf node (e.g. last node), which captures the information learned by the machine learning model 108.

Put another way, the trees rule model 110 traverses through an ensemble tree model provided in the machine learning model 108 and extracts a set of rules from each leaf of each tree, which captures the information learned by the machine learning model 108. The rules can be processed via a feature importance operation (to determine which rules contribute most significantly to the target variable of interest for prediction, e.g. fraud prediction) and the top k defined rules can be chosen by the trees rule model 110. The rules can be translated into SQL format for implementation in PRM system 112, as rules 114.

In at least some aspects, integrating a trees rule model 110 which extracts information from a machine learning model 108 trained on historical fraud data with a PRM system 112 enhances the system's capability to detect fraud transactions effectively, improve transparency, support real-time decision-making by associated computing devices including end device 118 and fraud alert system 116, adapt to dynamic fraud patterns, and optimize resource allocation, thereby strengthening overall transaction management systems. For example, continuous rule refinement based on ongoing machine learning outputs from the machine learning model 108 ensures adaptive fraud detection by the model, optimizing resource allocation and minimizing false positives across diverse transaction environments of the environment 150. The trees rule model 110, conveniently in at least some aspects, provides additional interpretability to the decisions made by the machine learning model 108 and thereby allows, in at least some aspects, to fine tune the machine learning model 108 as needed during a subsequent training, testing phase based on the extracted rules (e.g. if the rule set is biased or doesn't appropriately consider features of importance and thereby updating the model data 105 as needed to adjust the model).

In some aspects, there may be trade-offs between number of rules 114 that can be deployed versus capturing all the target variable prediction, e.g. digital account take over predicted by transaction risk model. Thus, in some aspects, if only a subset of trees rule Model 110 rules output is implemented as rules 114, then a base prediction is required to guide decisions for records that are not reflected in rule subset (e.g. rules 114). The base prediction could be the status quo rule set or could be defined during implementation of the engine 100.

In one example implementation, the trees rule model 110 is a Python-based machine learning module developed that provides fully interpretable tree ensembles. The algorithm traverses through the generated model 108, e.g. XGBoost tree and extracts rules from each leaf, which captures the information learned by the model. In at least one aspect, the rules generated by the trees rule model 110 can be ranked based on effect and the top k rules can be chosen for use and provided as rules 114 for use by the PRM system 112.

Referring to FIGS. 1 and 2, where FIG. 2 illustrates an example implementation of the blocks in FIG. 1, the following process may be followed by the Trees Rule Model 110 in cooperation with the modules of the real-time prediction model engine 100.
a. Input the machine learning model 108, e.g. XGBoost model json tree structure and feature names.
b. Traverse the trees using preorder traversal to get all the root-to-leaf paths (chained together, e.g. using & operation), which define the rules.
c. Output the tree features, including tree_id, rule, leaf score, leaf count, leaf proportion and effect for each tree in the machine learning model 108 (e.g. XGBoost ensemble model of step 1). The effect may be calculated as the leaf score multiplied by the leaf proportion for each node and is used for prediction.
d. Use the rule set for prediction in conjunction with a ‘default’ prediction for cases not captured by the rule set.

### Tuning of the Trees Rule Model 110

Referring again to FIGS. 1 and 2, the tuning of the trees rule model 110, e.g. as performed by one or more processors of the model engine 100 executing instructions in memory to cause the engine may include the following process:

In at least some aspects, the full rule set provides the same level of accuracy as the machine learning, e.g. XGBoost model 108. But if there are constraints that limit the number of rules, a rule subset may be identified. The trees rule model 110 may follow the following process to identify a rule subset:
a. Identify the accuracy by number of rules using a holdout training set
   i. Looping through X rules, use the X rules to predict holdout training set and generate model accuracy for the trees rule model 110
b. Select the rule subset that matches the desired accuracy level and use for rule set prediction.

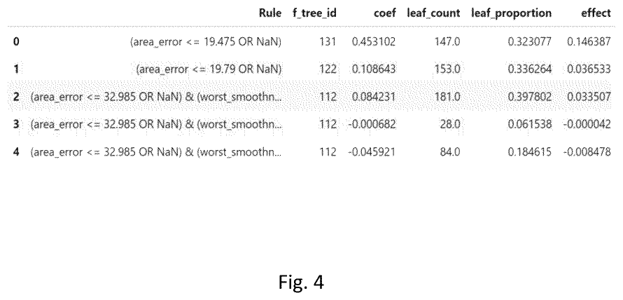

FIG. 4 illustrates a sample output from the trees rule model 110 which includes a set of rules, tree identification number, coefficient, leaf count, leaf proportion, and effect.

Referring again to FIGS. 1 and 2, generally, in at least some implementations, the machine learning model 108 learns which transactions are likely account take over fraud transactions amongst all transactions being processed in the current environment 150 amongst various data channels. Once the machine learning model 108 is generated, it may be used to introduce new rules into the PRM system 112 via the trees rule model 110 and create a single rule set which has paired down the rules to the important or most effective set of rules. Notably, in at least some aspects, the trees rule model 110 pulls all of the trees in the ensemble provided by the generated model 108, whereby each tree has its own branches and examines how it flows through each of the leaves as you traverse the trees, from the root node to the leaf node.

In one or more aspects, the trees rule model 110 may be configured to determine and identify the rules which are most common and group similar rules together in order to identify a higher level rule set. The rules may then be grouped based on their effect and the top defined set of rules may be chosen to proceed into the PRM system 112. These rules may then be translated by the rules model 110 into if, else statements implemented within SQL and ranked by importance.

### Proactive Risk Management System 112

Referring to FIGS. 1 and 2, the proactive risk management (PRM) system 112 is used to monitor and manage digital transactions 103 or other computing interactions and digital communications between computing devices, e.g. fraud transactions indicative of take over of accounts, across multiple digital channels (debit card transactions, online interactions, branch computers, point-of-sale system, etc.). PRM system 112 contains the data on transactions, traffic across environment 150 and fraud tagging. In some examples, a digital transaction may be any form of a digital transaction, which may occur in an online platform such as on a webpage, a mobile application, a digital mobile wallet with no human interaction. In at least some aspects, the PRM system 112 is an SQL-based system so the model results must either be implemented through SQL rules or a simple SQL-based model.

Generally, FIG. 2 illustrates an example implementation of the engine 100 and example flow of operations of FIG. 1 during real-time implementation, such as the machine learning model 108 being an XGBoost Model, the end device 118 comprising a plurality of end devices, including a fraud agent device 118A and a client device 118B. The transactions 103 including an account takeover fraud transaction and being monitored and managed by the PRM system 112 which communicates with a set of PRM rules 114 (e.g. SQL rules) and based on the set of rules generates a PRM alert on alert system 116 (or other type of response communication such as denying transactions related to the fraud transaction; denying communications from devices associated with the fraud; requiring additional authentication and authorization from devices associated with the fraud transaction, etc.) which may be reviewed and enacted on fraud agent device 118A and/or client device 118B including display of the alert notification on a user interface thereon and associated computerized action taken in response on transaction device or associated devices involved in transaction.

In one or more aspects, the proactive risk management (PRM) system 112 operates to monitor and manage digital transactions and interactions, such as fraud detection, across multiple channels like debit card transactions, online banking, branch activities, and point-of-sale systems.

In one or more aspects, the system 112 aggregates extensive transaction data, as may be communicated amongst various computing devices in the environment 150 across the network 106, including digital transactions, occurring through digital interfaces like the webpages, mobile applications, and mobile wallet. This data, alongside fraud tagging and other anomaly characteristics, is ingested and stored in a SQL database (e.g. SQL database 113). PRM system 112 employs continuous real-time monitoring, utilizing SQL-based rules 114 (which may also be stored in SQL database 113 once provided from the Trees Rules Model 110 and/or otherwise derived from the environment 150) and models to assess each new transaction against predefined criteria within the rules 114 (e.g. see example rule set in FIG. 4) to identify potential target variable, e.g. fraud or other risks and trigger subsequent actions, including alert, and/or managing or controlling transactions related to the alert.

For example, when a transaction satisfies the conditions specified by a rule in the rule set of rules 114 of FIGS. 1 and 2, it is flagged for further scrutiny, triggering alerts and notifications to relevant computing devices. The system 112 may also execute, in one or more example implementations, via the fraud alert system 116 preventive actions, such as transaction blocking at transaction level, account freezing related to the account for the transaction, denying subsequent transactions from the computing device or user associated with the flagged transaction, or requiring additional authentication from computing devices associated with the transaction, etc. In one or more aspects, the system 112 may trigger the fraud alert system 116 to generate the relevant computerized action on one or more devices such as end device 118. In some aspects, the PRM system 112 and/or fraud alert system 116 may select the action depend upon a predefined mapping of the rule or criteria within the rules 114 that was triggered and the degree from which the transaction deviates from the rule threshold. Conveniently, the interpretability of the rules provided by the engine 100 allows the system to analyze which of the rules are triggered and define appropriate computerized action, either at a transaction, network, or computing device level.

In one or more aspects, user input feedback on flagged transactions as may be received on end device 118 (e.g. feedback 119), fraud agent device 118A, client device 118B, etc. is incorporated back into the system 112 to iteratively refine and update the rules and models, such as the machine learning model 108 and thereby the trees rule model 110 and the PRM system 112 enabling the system to adapt to evolving fraud patterns and enhance its digital accuracy over time. By leveraging SQL-based data processing and rule execution, the PRM system 112 delivers a robust, efficient, and adaptive framework for proactive transaction management across diverse transaction channels.

In one or more aspects, the engine 100 utilizes the input feedback on the flagged transactions and/or actions (e.g. feedback 119 shown in FIG. 1) to modify the rules 114 and the sensitivities tested. For example, if the engine 100 determine that the fraud alert system 116 is generating too many alerts or too few alerts, this information may be fed back to the engine 100, e.g. the model 108 and/or the PRM system 112 and the rules can be modified to optimize to give more or less of any types of alerts. This feedback may cause retraining and reoptimization of one or more models in the engine 100.

### Fraud Alert System 116

In one or more aspects, the PRM system 112 may output or assign a probability of fraud. In some cases, the fraud alert system 116 may be configured to determine subsequent actions to trigger on the environment 150 and associated computing devices associated with the transactions of interest depending on the determined likelihood of fraud. For example, a staggered approach may be triggered such as triggering a computing signal indicative of an alert on one or more related computing devices associated with the transaction request (e.g. end device 118); stopping the particular transaction or transaction request or subsequent transactions associated with the potentially fraudulent determination; sending alert across computing environment 150 and network 106 to one or more transaction devices 104 and databases 102. Such alert may be visually displayed on one or more user interfaces of the user device, such as end device 118.

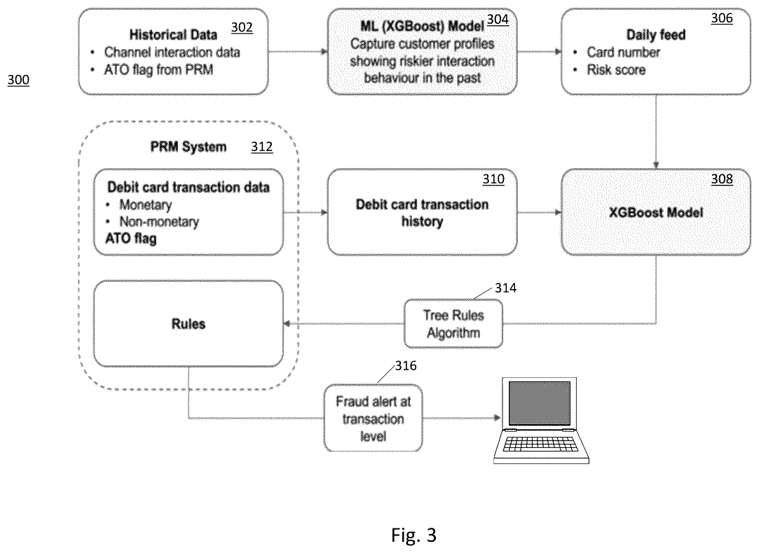

Referring now to FIG. 3 shown is an exemplary flow of operations 300 performed by the real-time prediction model engine 100 of FIGS. 1 and 2.

At operation 302, the engine 100 may be configured to obtain historical data comprising channel interaction data, flags indicative of prior fraudulent activity involving the identified transaction, the identified computing devices associated with the transaction. The flag may indicate for example, prior account takeover flags as identified by the PRM system 112 in a prior iteration or prior historical time event.

The channel interaction data may include detailed information about each historical transaction and the context in which it occurred, e.g. web traffic information. This may encompass transaction metadata such as unique transaction IDs, timestamps, transaction types, values, etc. It may also include channel-specific data, identifying the transaction channel (e.g., debit card, online banking, online merchants, mobile application, point-of-sale, digital wallet, etc.) and capturing device information like device IDs, types, browser details, URL or IP address, and application versions. Additionally, user information such as unique user IDs and account details (e.g., account numbers) may be included to provide a comprehensive view of the transaction context for effective monitoring and fraud detection.

Such historical data at operation 302 may be used as model data 105 to generate (e.g. train/test/and validate) the machine learning model 108.

At operation 304, the machine learning model 108 may be trained and tested to capture and identify customer profiles having riskier interaction behaviours in the past. Some of the model development parameters may include:
a. Target: PRM detail flag history (identified by product type and mark type)
b. Sampling: defined percentage of the entire population of transactions (defined as all transactions occurred in certain time period). Predefined percentage of which was used as the training set and remaining as the testing set. The sample size may also be limited by the maximum limit that the model, e.g. XGBoost package could ingest for training. The percentage split of training and testing data may be reassessed to ensure representative of fraud population.
c. Features: Feature importance may be performed on the model (e.g. Shapley values) to reduce feature set and retain features with highest feature contribution or importance of each feature on the prediction of the model (irrelevant columns and the target column were reduced).

As noted earlier, the historical data at operation 302, may include PRM data, which is a fraud detection and management system for transactions and enterprise data warehouse data (EDW) which is a data warehouse repository of customer centric information.

At operation 306, new transactions are monitored by the engine 100 (e.g. may be passively monitored and collected from various data sources across various data channels as mentioned earlier). The daily feed of transactions, including transaction details, e.g. card number, and potential risk score (e.g. based on the PRM system of fraud) may be provided to the trained machine learning model, XGBoost model at operation 308. The XGBoost model may also be fed various data from the PRM system (e.g. PRM system 112 including PRM rules 114) from operation 312 including various channel transaction history, such as debit card transaction history at 310. The information may be combined by the XGBoost model at operation 308, to generate the model and apply the transactions thereto.

At operation 314, the trees rule model 110 is applied which traverses through the ensemble tree model provided by the XGBoost model at operation 308 and extracts rules from each leaf, which captures the information learned by the model. The rules can be reduced to those top k rules (e.g. with highest effect) and translated into SQL for implementation in PRM system 112 at operation 312. The trees rule model 110 may be configured to traverse the boosted tree output to generate a series of deterministic rules, e.g. a simple set of rules which define that a transaction is flagged because of a set of transaction features meeting certain criteria (e.g. from a new IP address). This rule set which is distilled is what allows the computing system and engine 100 to be implemented in real time, that is, this type of traversal provides a computationally simple implementation which may be applied to new transactions received.

The PRM system 112 may then be applied via its rules 114 to new transactions, such as to flag transactions meeting one or more of the criteria defined in the rule set and trigger an alert at an operation 316 on one or more computing devices as described herein. Such alert may alert users of the end computing device to the increased likelihood of fraud takeovers associated with transactions involving the one or more parties associated with the transaction (e.g. online merchant, online user, etc.). The alert many be communicated to one or more user devices across the network 106 using communication protocols. In one or more aspects, the end device 118 (e.g. fraud agent 118A or client device 118B) may render and display the alert and associated detail notifications within a portion of a viewing screen or corresponding display unit on the computing device for subsequent input and feedback thereon, which may be fed back to the engine 100 for further revising of the model and generated rules 114. The operation 316 may include the engine 100 determining a set of transaction related actions from a set of possible actions to be performed based on specifics identifying the transaction, the likelihood of fraud identified and the one or more rules triggered by the incoming transaction. That is, different rules may be assigned to different transaction related actions in the rules 114 of the PRM system 112.

Thus, in at least some implementation by utilizing a machine learning model 108 such as to improve limitations of an initial version of a PRM system in improved prediction detection and mapping the output model to a set of rules via the trees rule model 110 which is explainable and implementable in real time by providing at least a subset of these rules translated into SQL format into the PRM system 112 for implementation thereof, allows faster processing time of the overall system for managing and flagging subsequent transactions in real-time.

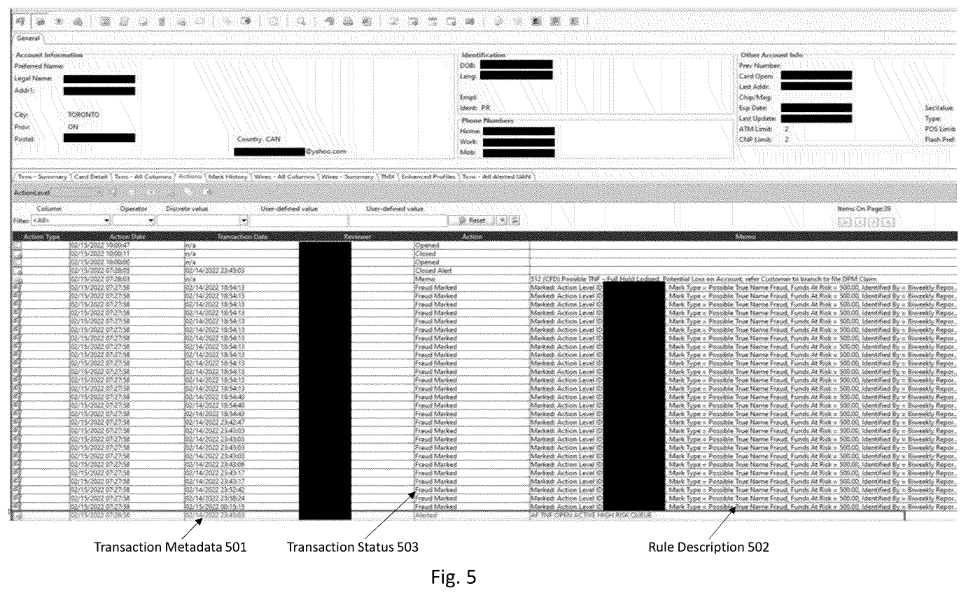

FIG. 5 illustrates an exemplary action log including transactions alerted as fraud as may be displayed on end device 118 or computing device associated with the PRM system 112. The action log displays in viewing panes or regions of the screen of a computing device (e.g. end device 118) concurrently the action type, the action date, the transaction date, the action to be taken, and textual reasoning associated with the flagging of fraud which may include the rules within the PRM system that were triggered or met when the threshold for those rules was met or exceeded by the transaction features. The user interface also is configured to receive input feedback (e.g. feedback 119) on whether the flagged marking is accepted or not and thus retune and readjust the engine 100, e.g. the machine learning model 108 and thereby the rules 114 in a subsequent iteration of the system. Such modification of the risk level via the display unit of the end device 118 may be reflected in the visual display of the action log to reflect the change in the risk level and trigger submitting the update to one or more associated computing devices of the model engine 100 for subsequent revisions.

Referring to FIG. 5, the display unit of the end device 118, fraud agent device 118A, or client device 118B may receive a communication signal provided by the real-time prediction model engine 100, indicative of the PRM alert, or alert indication for a given transaction and thereby illustrate on a display unit of the computing device, notification viewing portions indicating transaction metadata 501 identifying each transaction in a set of transaction, transaction status 503 (e.g. indicative of whether a rule within the PRM rule set has been triggered for a particular transaction), and corresponding rule description 502, describing textually the one or more rules triggered by each transaction defined in the log.

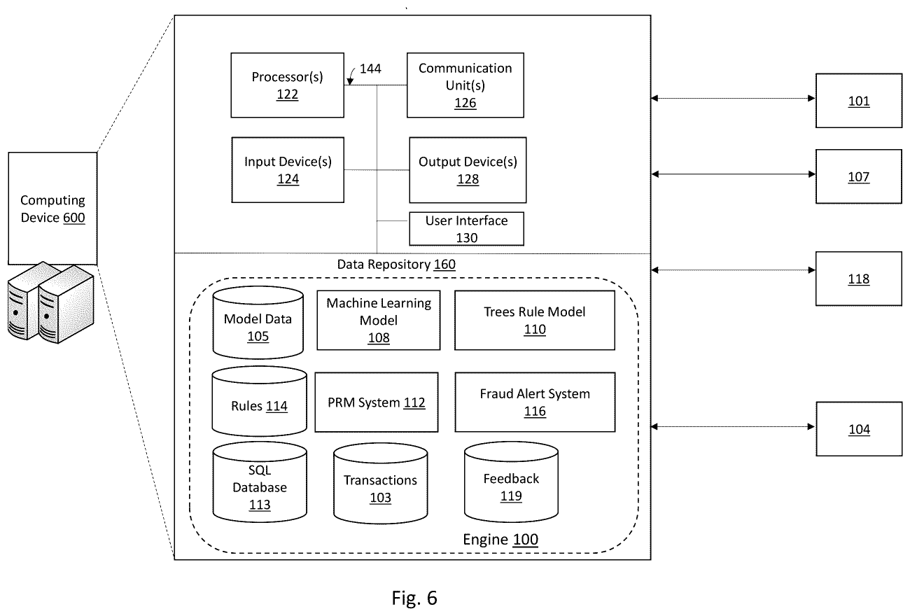

Reference is next made to FIG. 6 which is a diagram illustrating in block form an example computing device, e.g. a computer device 600 for providing the engine 100 and for use in the communication system and environment 150 of FIG. 1.

The computing device 600 includes at least one processor 122 (such as a microprocessor) which controls the operation of the engine 100 and the computing device 600. The processor 122 is coupled to a plurality of components and computing components via a communication bus or channel, shown as the communication channel 144.

Device 600 may perform one or more processes and operations described herein based on the processors 122 executing software instructions stored by a computer readable medium such as memory in a data repository 160. A computer readable medium is defined herein as a non-transitory computer readable medium or memory device. Software instructions may be read into the data repository 160, and when executed may cause the processor 122 to perform one or more of the processes and operations described herein including the example operations of FIG. 3.

Computing device 600 further comprises one or more input devices 124, one or more communication units 126, one or more output devices 128, a user interface 130 and one or more database or data repository components. The computing device 600 also includes one or more data repositories 160 storing one or more computing modules and components such as, but not limited to: a machine learning model 108, a PRM system 112, a trees rule model 110, a fraud alert system 116, various data sources and databases storing model data 105, rules 114, SQL database 113, transactions 103, feedback 119 and other computing components to enable the functionality as described herein with reference to FIGS. 1-5.

Communication channels 144 may couple each of the components for inter-component communications, including machine learning model 108, trees rule model 110, PRM system 112, fraud alert system 116, various data stores whether communicatively, physically and/or operatively. In some examples, communication channels 144 may include a system bus, a network connection, an inter-process communication data structure, or any other method for communicating data. The communication channels 144 may also be used for the modules to communicate with various external computing devices and components of the environment 150 of FIG. 1 including the requesting device 101, transaction devices 104, transaction database 102, EDW 107, end device 118, etc.

Referring to FIG. 6, one or more processors 122 may implement functionality and/or execute instructions within computing device 600. The processor 122 is coupled to a plurality of computing components via the communication bus or communication channel 144 which provides a communication path between the components and the processor 122. For example, processors 122 may be configured to receive instructions and/or data from storage devices, e.g. data repository 160, to execute the functionality of the computing modules shown in FIG. 6, among others (e.g. operating system, applications, etc.). The computing device 600 may store data/information as described herein for the process of generating a fraud prediction and managing large number of transactions communicated in a networked environment and delivering results to one or more computing devices, such as end device 118, by way of user interface 130. Some of the functionality is described further herein.

One or more communication units 126 may communicate with external devices via one or more networks (e.g. communication network 106) by transmitting and/or receiving network signals on the one or more networks. The communication units may include various antennae and/or network interface cards, etc. for wireless and/or wired communications.

Input devices 124 and output devices 128 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 144).

The one or more data repositories 160 may store instructions and/or data for processing during operation of the engine 100, e.g. as described with reference to FIG. 3. The one or more storage devices may take different forms and/or configurations, for example, as short-term memory or long-term memory. Data repositories 160 may be configured for short-term storage of information as volatile memory, which does not retain stored contents when power is removed. Volatile memory examples include random access memory (RAM), dynamic random access memory (DRAM), static random access memory (SRAM), etc. Data repositories, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Referring again to FIG. 6, it is understood that operations may not fall exactly within the modules described such that one module may assist with the functionality of another.

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

The term “a” or “an” refers to one or more of that entity; for example, “a device” refers to one or more device or at least one device. As such, the terms “a” (or “an”), “one or more” and “at least one” are used interchangeably herein. In addition, reference to an element or feature by the indefinite article “a” or “an” does not exclude the possibility that more than one of the elements or features are present, unless the context clearly requires that there is one and only one of the elements. Furthermore, reference to a feature in the plurality (e.g., devices), unless clearly intended, does not mean that the systems or methods disclosed herein must comprise a plurality.

The expression “and/or” refers to and encompasses any and all possible combinations of one or more of the associated listed items (e.g. one or the other, or both), as well as the lack of combinations when interrupted in the alternative (or).

One or more currently preferred embodiments have been described by way of example. It will be apparent to persons skilled in the art that a number of variations and modifications can be made without departing from the scope of the disclosure as defined in the claims.

1. A model engine apparatus for receiving a plurality of transactions from at least one transaction server and managing the transactions for one or more computing devices over a network, the model engine apparatus comprising:
a machine learning model using a supervised learning model being trained and tested on historical transaction data including labelled fraud data received from the at least one transaction server, configured to provide a target signal indicative of a likelihood of fraud within a given transaction, the machine learning model generating an ensemble of decision trees as output;
a trees model for extracting a set of rules by traversing each tree in the ensemble of decision trees from a root node to each leaf node of the tree, each path from the root node to a particular leaf node including splitting criterion providing a rule to form a set of rules for the ensemble; and
a proactive risk management system for receiving the set of rules, and storing the rules in a database for applying the set of rules to compare to a new transaction received from the at least one transaction server, and in response to at least one rule being met for the new transaction, triggering predetermined actions on at least one computing device on the network associated with the new transaction based on the at least one rule being met.

2. The model engine apparatus of claim 1, wherein triggering the predetermined actions further comprises triggering generating an alert and presenting on a display unit of the at least one computing device, a first notification portion indicative of likelihood of fraud, a second notification portion indicative of the at least one rule met and a third notification portion indicative of metadata identifying the new transaction.

3. The model engine apparatus of claim 2, comprising receiving feedback from the at least one computing device, via receiving user input on the display unit modifying the likelihood of fraud, and providing such to the machine learning model to cause the machine learning model to be retrained to incorporate the feedback and thereby generate a new set of rules for the proactive risk management system.

4. The model engine apparatus of claim 1, wherein the machine learning model further receives an existing set of rules from the proactive risk management system and additional historical data from the proactive risk management system indicative of modifications to the set of rules thereby causing regeneration of the machine learning model.

5. The model engine apparatus of claim 1, wherein the trees model is further configured to reduce the set of rules prior to providing to the proactive risk management system by grouping together similar rules or common rules, the similar rules being grouped together based on a similarity metric.

6. The model engine apparatus of claim 1, wherein the trees model is further configured to reduce the set of rules prior to providing to the proactive risk management system by ranking each rule in the set of rule based on effect on determining the target signal and selecting a top defined number of set of rules for said providing to the proactive risk management system for implementation on incoming transactions.

7. The model engine apparatus of claim 1, wherein the trees model is further configured to translate the set of rules into SQL rules in a format compatible with the proactive risk management system.

8. The model engine apparatus of claim 1, wherein the proactive risk management system is further configured to trigger a staggered response to the at least one rule being met, wherein the staggered response defined a different level of response to be performed by the computing devices being managed, the different level of response comprising at least one of: denying the new transaction; generating an alert to the computing devices associated with the new transaction; generating an alert to the computing devices requesting the new transaction; and requesting additional authentication from the computing devices requesting the new transaction.

9. The model engine apparatus of claim 1, wherein the machine learning model is configured to train on a subset of the historical transaction data, the machine learning model to rebalance the subset until representative of a proportion of fraudulent transactions versus normal transactions in a complete set of the historical transaction data.

10. A computer implemented method for receiving a plurality of transactions from at least one transaction server and managing the transactions for one or more computing devices over a network, the method comprising:
generating a machine learning model using a supervised learning model being trained and tested on historical transaction data including labelled fraud data received from the at least one transaction server, the machine learning model configured to provide a target signal indicative of a likelihood of fraud within a given transaction, the machine learning model generating an ensemble of decision trees as output;
applying a trees model for extracting a set of rules by traversing each tree in the ensemble of decision trees from a root node to each leaf node of the tree, each path from the root node to a particular leaf node including splitting criterion providing a rule to form a set of rules for the ensemble; and
providing the set of rules to a proactive risk management system and storing the rules in a database and applying the set of rules upon receiving a new transaction from the at least one transaction server, and in response to at least one rule being met for the new transaction, triggering predetermined actions on at least one computing device on the network associated with the new transaction based on the at least one rule being met.

11. The method of claim 10, wherein triggering the predetermined actions further comprises triggering generating an alert and presenting on a display unit of the at least one computing device, a first notification portion indicative of likelihood of fraud, a second notification portion indicative of the at least one rule met and a third notification portion indicative of metadata identifying the new transaction.

12. The method of claim 11, comprising receiving feedback from the at least one computing device, via receiving user input on the display unit modifying the likelihood of fraud, and providing such to the machine learning model to cause the machine learning model to be retrained to incorporate the feedback and thereby generate a new set of rules for the proactive risk management system.

13. The method of claim 10, further comprising the machine learning model receiving an existing set of rules from the proactive risk management system and additional historical data from the proactive risk management system indicative of modifications to the set of rules thereby causing regeneration of the machine learning model.

14. The method of claim 10, further comprising, reducing the set of rules via the trees model prior to providing to the proactive risk management system by grouping together similar or common rules, the similar rules being grouped together based on a similarity metric.

15. The method of claim 10, further comprising reducing the set of rules, via the trees model prior to providing to the proactive risk management system by ranking each rule in the set of rule based on effect on determining the target signal and selecting a top defined number of set of rules for said providing to the proactive risk management system for implementation on incoming transactions.

16. The method of claim 10, further comprising translating the set of rules into SQL rules in a format compatible with the proactive risk management system prior to providing to the proactive risk management system for application.

17. The method of claim 10, further comprising triggering a staggered response to the at least one rule being met, wherein the staggered response defined a different level of response to be performed by the computing devices being managed, the different level of response comprising at least one of: denying the new transaction; generating an alert to the computing devices associated with the new transaction; generating an alert to the computing devices requesting the new transaction; and requesting additional authentication from the computing devices requesting the new transaction.

18. The method of claim 10, wherein the machine learning model is configured to train on a subset of the historical transaction data, and further comprising rebalancing the subset until representative of a proportion of fraudulent transactions versus normal transactions in a complete set of the historical transaction data.

19. A non-transitory computer readable medium having instructions thereon, which when executed by a processor of a computer configure the computer to perform a method for receiving a plurality of transactions from at least one transaction server and managing the transactions for one or more computing devices over a network, the method comprising:
generating, by the processor a machine learning model using a supervised learning model being trained and tested on historical transaction data including labelled fraud data received from the at least one transaction server, the machine learning model configured to provide a target signal indicative of a likelihood of fraud within a given transaction, the machine learning model generating an ensemble of decision trees as output;
applying, by the processor, a trees model for extracting a set of rules by traversing each tree in the ensemble of decision trees from a root node to each leaf node of the tree, each path from the root node to a particular leaf node including splitting criterion providing a rule to form a set of rules for the ensemble; and
providing, by the processor, the set of rules to a proactive risk management system and storing the rules in a database and applying the set of rules upon receiving a new transaction from the at least one transaction server, and in response to at least one rule being met for the new transaction, triggering predetermined actions on at least one computing device on the network associated with the new transaction based on the at least one rule being met.
